(19) United States
(12) Patent Application Publication
(10) Pub. No.: US 2021/0264822 A1
(43) Pub. Date: Aug. 26, 2021

(54) REFLECTIVE FLEXIBLE DISPLAY DEVICE

(71) Applicant: InnoLux Corporation, Miao-Li County (TW)

(72) Inventors: Toshiya Inada, Miao-Li County (TW); Yu-Chih Tseng, Miao-Li County (TW); Hsin-Hao Huang, Miao-Li County (TW); Chu-Hong Lai, Miao-Li County (TW); Cheng-Jen Chu, Miao-Li County (TW)

(21) Appl. No.: 17/148,511

(22) Filed: Jan. 13, 2021

(30) Foreign Application Priority Data
Feb. 25, 2020 (CN) 202010117371.3

(51) Int. Cl. G09F 9/30; G02F 1/1333; G02F 1/1339; G02F 1/13363; G02F 1/1335

(52) U.S. Cl. CPC G09F 9/301; G02F 1/133305; G02F 1/133528; G02F 1/13363; G02F 1/1339

(57) ABSTRACT

A reflective flexible display device includes a liquid crystal layer disposed between a first flexible substrate and a second flexible substrate, and a reflective pixel electrode disposed on the first flexible substrate. A CIELAB b* coordinate of the second flexible substrate is less than or equal to a CIELAB b* coordinate of the first flexible substrate.

### BACKGROUND OF THE DISCLOSURE

### 1. Field of the Disclosure

The present disclosure relates to a reflective flexible display device, in particular, the CIELAB b* coordinate of one of the flexible substrates therein is less than or equal to the CIELAB b* coordinate of another flexible substrate.

### 2. Description of the Prior Art

A reflective display device saves more power because the reflective display device omits the backlight module. However, in order to support a large display device, the reflective display device often uses a rigid substrate, such as glass. The larger the reflective display device may occupy more space, which causes poor space utilization, thereby reducing the application flexibility.

### SUMMARY OF THE DISCLOSURE

In view of this, there is a need to propose a reflective display device to solve the technical problems which the current reflective display devices have. One of the objectives of the present disclosure is to provide a reflective flexible display device which has a thinner thickness and a lighter weight to become an electronic product which may be easily moved or stored or increasing the flexibility of application.

A reflective flexible display device proposed in the present disclosure includes a reflective pixel electrode, a liquid crystal layer, a first flexible substrate and a second flexible substrate. The liquid crystal layer is disposed between the first flexible substrate and the second flexible substrate. The reflective pixel electrode is disposed on the first flexible substrate. The CIELAB b* coordinate of the second flexible substrate is less than or equal to the CIELAB b* coordinate of the first flexible substrate.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic diagram to illustrate the structure of the reflective flexible display device of the first embodiment of the present disclosure, and the structures of some elements are shown in a cross-sectional view.

FIG. 2 is a schematic diagram to illustrate the structure of the reflective flexible display device of the second embodiment of the present disclosure, and the structures of some elements are shown in an exploded view.

FIG. 3 is a schematic diagram to illustrate the structure of the reflective flexible display device of the third embodiment of the present disclosure, and the structures of some elements are shown in a cross-sectional view.

FIG. 4A shows an embodiment of the reflective flexible display device according to the fourth embodiment of the present disclosure.

FIG. 4B illustrates another embodiment of the reflective flexible display device of the fourth embodiment of the present disclosure.

### DETAILED DESCRIPTION

To provide a better understanding of the present disclosure to those skilled in the art, embodiments will be detailed as follows. The embodiments of the present disclosure are illustrated in the accompanying drawings with numbered elements to elaborate on the contents and effects to be achieved. It is needed to note that the drawings are simplified schematic diagrams, and therefore, the drawings show only the components and combinations associated with the present disclosure, and to provide a clearer description of the basic architecture or method of implementation of the present disclosure. The components would be complex in reality. In addition, for explanation, the components shown in the drawings of the present disclosure are not drawn to the actual number, shape, and dimensions.

Certain terms are used throughout the description and following claims to refer to particular components. As one skilled in the art will understand, electronic equipment manufacturers may refer to a component by different names. This document does not intend to distinguish between components that differ in name but not in function. In the following description and in the claims, the terms “include”, “comprise” and “have” are used in an open-ended fashion, and thus should be interpreted to mean “include, but not limited to . . . ”.

It will be understood that when an element or layer is referred to as being “on another component or on another layer” or “connected to another component or to another layer”, it can be directly on or directly connected to the other element or layer, or intervening elements or layers may be presented. In contrast, when an element is referred to as being “directly on” or “directly connected to” another element or layer, there are no intervening elements or layers presented. In addition, the word “electrically connected” may include any direct or indirect electrical connection means.

The terms “about”, “substantially”, “equal”, or “ₛₐₘₑ” generally mean within 20% of a given value or range, or mean within 10%, 5%, 3%, 2%, 1%, or 0.5% of a given value or range.

It should be noted that the technical features in different embodiments described in the following can be replaced, recombined, or mixed with one another to constitute another embodiment without departing from the spirit of the present disclosure.

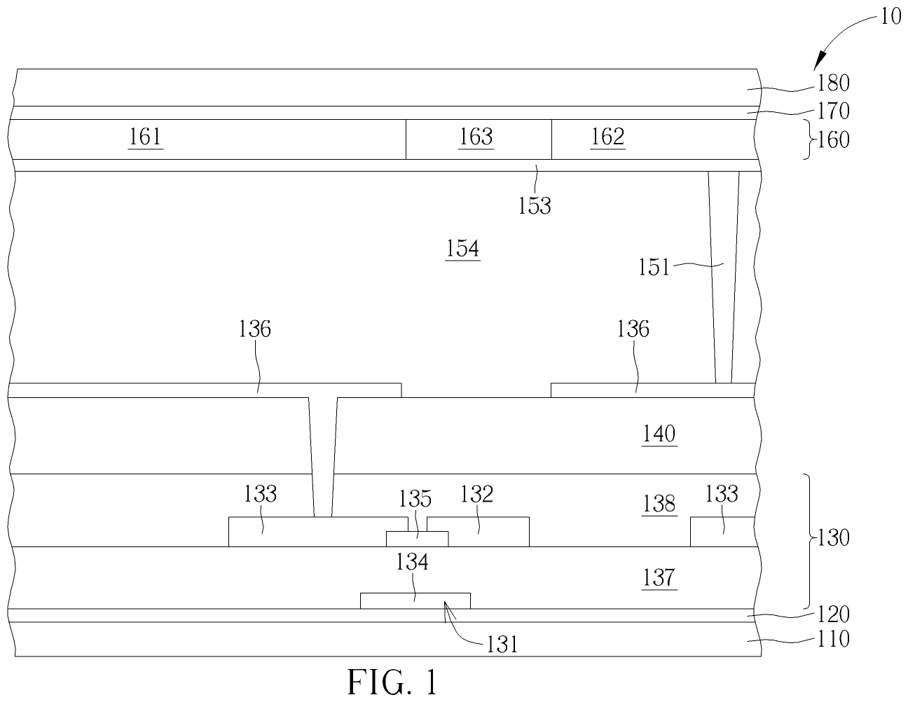

FIG. 1 is a schematic diagram to illustrate the structure of a reflective flexible display device of the first embodiment of the present disclosure, and the structures of some elements are shown in a cross-sectional view. The reflective flexible display device 10 of the first embodiment of the disclosure includes a first flexible substrate 110, a second flexible substrate 180, a reflective pixel electrode 136, and a liquid crystal layer 154. The liquid crystal layer 154 is disposed between the first flexible substrate 110 and the second flexible substrate 180. The reflective pixel electrode 136 is disposed on the first flexible substrate 110. Optionally, the reflective flexible display device 10 may further include a first buffer layer 120, a transistor array layer 130, a protective layer 140, a filter layer 160, and a second buffer layer 170. The first flexible substrate 110 and the second flexible substrate 180 may replace traditional glass, and the reflective flexible display device 10 of the present disclosure is flexible. The term “flexible” here refers to the reflective flexible display device in various embodiments of the present disclosure which may be curved, bent, folded, rolled, stretched and/or other similar deformations. In the following, “flexible” refers to at least one possible deformation method as mentioned above, but the present disclosure is not limited thereto.

The reflective flexible display device 10 may include, for example, a tiled device, such as a tiled display device, but the present disclosure is not limited thereto. The first flexible substrate 110 and the second flexible substrate 180 may respectively comprise a flexible polymer material, for example, polyimide (PI), polyethylene terephthalate (PET), other suitable flexible materials or a combination of the above materials, but the present disclosure is not limited thereto. The thickness of the first flexible substrate 110 may be between 1 micrometer (μm) and 45 μm. For example, the thickness of the first flexible substrate 110 may be between 30 μm and 40 μm. The thickness of the second flexible substrate 180 may be between 1 μm and 45 μm. For example, the thickness of the second flexible substrate 180 may be between 30 μm and 40 μm. The first flexible substrate 110 and the second flexible substrate 180 may reduce the total thickness of the reflective flexible display device 10 and the reflective flexible display device 10 of the present disclosure have a thinner thickness and a lighter weight, to become an electronic product which may be easily moved or stored.

The material of the first flexible substrate 110 and the material of the second flexible substrate 180 may be the same or different. When the material of the first flexible substrate 110 is different from the material of the second flexible substrate 180, the transparency of the first flexible substrate 110 and the transparency of the second flexible substrate 180 may be different. For example, the optical transmittance of the second flexible substrate 180 may be higher than the optical transmittance of the first flexible substrate 110, or the transparency of the second flexible substrate 180 may be higher than the transparency of the first flexible substrate 110. The “transparency” here refers to the b* coordinate of the color defined by the color space CIELAB of International Commission on Illumination between yellow color and blue color. For example, a material is more transparent when its b* coordinate is closer to 0. For example, the CIELAB b* coordinate of the second flexible substrate 180 may be less than or equal to the CIELAB b* coordinate of the first flexible substrate 110. For example, the CIELAB b* coordinate of the second flexible substrate 180 may be less than or equal to 10, but the present disclosure is not limited thereto. For instance, the CIELAB b* coordinate of the second flexible substrate 180 may be close to 0 and it is more transparent to be beneficial to the light emission of the reflective flexible display device 10. The first flexible substrate 110 may be a polyimide material which is relatively transparent or yellowish. For example, its CIELAB b* coordinate may be greater than or equal to 10, but the present disclosure is not limited thereto. The first flexible substrate 110 may also have better thermal stability. For example, the glass transition temperature (Tg) of the first flexible substrate 110 may be greater than 250° C., but the present disclosure is not limited thereto. When the first flexible substrate 110 has better thermal stability, it may facilitate the manufacturing processes of the material layers thereon, such as the manufacturing process of the first buffer layer 120, the transistor array layer 130, and the protective layer 140.

At least one buffer layer, such as the first buffer layer 120 or the second buffer layer 170, may be respectively formed on the surface of the first flexible substrate 110 or of the second flexible substrate 180, and may facilitate the arrangement of subsequent components in the reflective flexible display device 10. For example, the first buffer layer 120 may facilitate the arrangement of the transistor array layer 130 in the reflective flexible display device 10, and the second buffer layer 170 may facilitate the arrangement of the filter layer 160 in the reflective flexible display device 10. One of the functions of the buffer layers includes the reduction of the damage to the flexible substrates during the manufacturing process of the elements, or the reduction of the invasion of moisture or oxygen into the interior of the reflective flexible display device 10, but the present disclosure is not limited thereto. The first buffer layer 120 or the second buffer layer 170 may include, for example, but not limited to, an oxide layer, a nitride layer or other suitable materials, such as silicon oxide (SiOx), silicon nitride (SiNy), silicon oxynitride (SiOxNy) or a combination thereof, but the present disclosure is not limited thereto.

The transistor array layer 130 may be disposed on the first buffer layer 120 on the first flexible substrate 110. The transistor array layer 130 may include, for example, at least one conductive layer, at least one semiconductor layer, at least one insulating layer to form a plurality of thin-film transistors 131 and a plurality of data lines (not shown), a plurality of gate lines (not shown), bonding pads (not shown), other wires or electronic components (such as capacitors, reset components, compensation components, control components, etc.) (not shown) in the reflective flexible display device 10, but the present disclosure is not limited thereto. The thin-film transistor 131 may serve as a driving element to control the rotation of the liquid crystal molecules in the liquid crystal layer 154, but the present disclosure is not limited thereto. For example, the thin-film transistor 131 may be a bottom gate transistor, including a gate 134 (for example, a part of a gate line), a source 132 (for example, apart of a data line), a drain 133, a semiconductor layer 135 as a channel, and a dielectric layer 137 as agate insulating layer. An optional dielectric layer 138 or an optional protective layer 140 may be provided on the source electrode 132 and the drain electrode 133. The dielectric layer 137, the dielectric layer 138 and the protective layer 140 may be an inorganic material or an organic material, respectively. The thin-film transistor 131 may be electrically connected to the reflective pixel electrode 136 through the holes penetrating the dielectric layer 138 and the protective layer 140 to control the corresponding pixels. The source 132, the drain 133, the gate 134, the data lines and the gate lines may be made of a conductive material, such as metals, for example aluminum (Al), copper (Cu), titanium (Ti), molybdenum (Mo), suitable materials or a combination thereof, but the present disclosure is not limited thereto. In addition, the dielectric layer 137 may be disposed on the first buffer layer 120, and the dielectric layer 138 may be disposed on the dielectric layer 137 to cover the thin-film transistor 131. In addition, the protective layer 140 may cover the dielectric layer 138. The thin-film transistor 131 may also be a top gate transistor, but the present disclosure is not limited thereto.

A plurality of spacers 151 may be provided between the first flexible substrate 110 and the second flexible substrate 180. A plurality of reflective pixel electrodes 136 and a common electrode 153 may be respectively disposed on the first flexible substrate 110 and on the second flexible substrate 180, but the present disclosure is not limited thereto. The plurality of reflective pixel electrodes 136 may comprise materials of reflective property. In an embodiment, the reflective pixel electrode 136 may be additionally covered with a transparent electrode (not shown), so the reflective pixel electrode 136 may also be an electrode of a composite structure, but the present disclosure is not limited thereto. The reflective pixel electrode 136 may comprise a metal material such as aluminum, to reflect incident light (not shown) entering the liquid crystal layer 154 from the outside, but the present disclosure is not limited thereto. The transparent electrode may be a conductive material with high optical transmission properties, such as indium tin oxide (ITO) or indium zinc oxide (IZO) or other suitable materials, but the present disclosure is not limited thereto. The liquid crystal material in the liquid crystal layer 154 may include various suitable materials such as a nematic liquid crystal, a smectic liquid crystal, and a cholesteric liquid crystal, but the present disclosure is not limited thereto.

The filter layer 160 may include a color filter 161, a color filter 162 and a light-shielding layer 163. The color filter 161 or the color filter 162 may be respectively one of a red filter, a green filter or a blue filter, but the present disclosure is not limited thereto. A light-shielding layer 163 may be provided between adjacent the color filter 161 and the color filter 162. The light-shielding layer 163 may be, for example, a black matrix layer (BM) or a colored photoresist material layer, or may be formed by stacking at least two different color filters, but the present disclosure is not limited thereto. The common electrode 153 may comprise a conductive material with high optical transmission properties, for example a transparent conductive material such as indium tin oxide or indium zinc oxide or other suitable materials, but the present disclosure is not limited thereto.

Generally speaking, traditional reflective display devices generally use rigid support materials such as glass, and the thickness of the rigid support materials is up to 0.2 millimeters (mm) to 0.5 millimeters. Since the reflective flexible display device 10 of the present disclosure uses the first flexible substrate 110 and the second flexible substrate 180, and the reflective flexible display device 10 of the present disclosure may be flexible. On the other hand, it may reduce the incident light from the outside to be reflected by the interface between the different material layers to irradiate the channel layer, such as the semiconductor layer 135, because the thickness of the flexible substrate is lower than that of the general glass substrate or may not affecting the imaging quality.

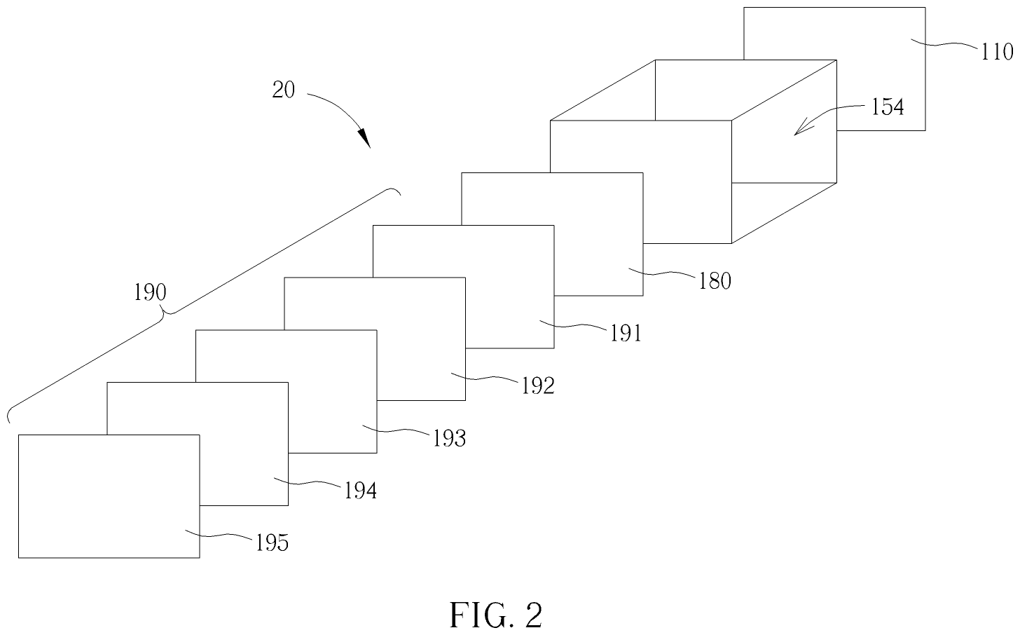

FIG. 2 is a schematic diagram to illustrate the structure of the reflective flexible display device of the second embodiment of the present disclosure, and the structures of some elements are shown in an exploded view. The reflective flexible display device 20 of the second embodiment of the present disclosure may include a first flexible substrate 110, a second flexible substrate 180, a liquid crystal layer 154, and an optical layer 190 disposed on the second flexible substrate 180. The optical layer 190 may be one or more film layers, for example, including an optical compensation film 191, a scattering layer 192, a first phase retardation film 193, a second phase retardation film 194, and a polarizing film 195, but the present disclosure is not limited thereto. The optical layer 190 may be used to adjust the optical properties of the reflective flexible display device 20. In some embodiments, the optical layer 190 used for optical adjustment may also be disposed between the first flexible substrate 110 and the second flexible substrate 180, but the present disclosure is not limited thereto.

If a film layer used in the display device has a birefringent optical property, the film with the birefringent optical property may cause the passing light to have a phase difference and affect the image quality. At this time, a film layer in the optical layer 190, for example, an optical compensation film 191 for phase adjustment, may be used to adjust the phase difference when the film layer with the birefringent optical property. In an embodiment, the optical compensation film 191 may adjust the phase difference when the light passing through the second flexible substrate 180. The scattering layer 192 may make the light have a diffusing state after passing through or may be beneficial to increase the viewing angle of the reflective flexible display device 20. The first phase retardation film 193 or the second phase retardation film 194 may be respectively used to adjust the optical properties, such as the phase of the light, of the light after passing through the first phase retardation film 193 or through the second phase retardation film 194. The polarizing film 195 may be used to determine the polarization properties of the light after passing through.

When polyimide is taken as an example for the flexible substrates, since the flexible substrates are a biaxial film, the optical compensation film 191 of different thickness needs to go with the thickness of the flexible substrates. By integrating the optical compensation film 191 into the optical layer 190, the image quality may be improved. For example, if the thickness of the second flexible substrate 180 is between 1 μm and 45 μm, the compensation value range of the optical compensation film 191 to go with may be 0<R₀<1 nanometer (nm), 30 nanometers <Rₜₕ<300 nm, where R₀ is the in-plane retardation and Rₜₕ is the out-of-plane retardation.

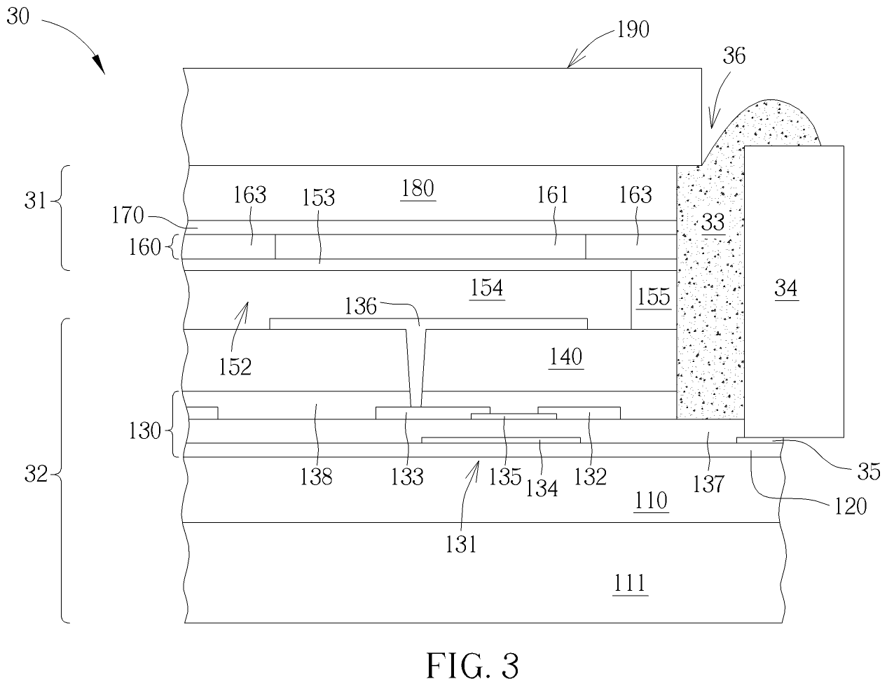

FIG. 3 is a schematic diagram to illustrate the structure of the reflective flexible display device of the third embodiment of the present disclosure, and the structures of some elements are shown in a cross-sectional view. The reflective flexible display device 30 of the third embodiment of the present disclosure may include a carrier 111, a first flexible substrate 110, a transistor array layer 130, a protective layer 140, a liquid crystal layer 154, a filter layer 160, a second flexible substrate 180 and an optical layer 190. The reflective flexible display device 30 of the third embodiment of the present disclosure may be assembled from the second substrate set 31 and the first substrate set 32 to form a large plate structure after an alignment step, and form a display panel after an appropriate cutting step, and further form the reflective flexible display device 30 after an appropriate assembling steps. The manufacturing process of the reflective flexible display device 30 is briefly described in the following, but the present disclosure is not limited thereto.

First, a carrier 111 may be provided, and the first flexible substrate 110 may be located on the carrier 111. The carrier 111 may be, for example, a rigid substrate, such as a glass substrate, but the present disclosure is not limited thereto. The thickness of the carrier 111 may be between 500 μm and 1000 μm, but the present disclosure is not limited thereto.

The material selection or the CIELAB b* coordinate or the thickness or the range of the glass transition temperature of the first flexible substrate 110 may be as described above, and not elaborated again, but the present disclosure is not limited thereto. As described above, for example, the CIELAB b* coordinate of the second flexible substrate 180 may be less than or equal to the CIELAB b* coordinate of the first flexible substrate 110. The first flexible substrate 110 may be a relatively transparent or yellowish polyimide material. For example, the CIELAB b* coordinate may be greater than or equal to 10, but the present disclosure is not limited thereto. The first flexible substrate 110 may have better thermal stability as described above to facilitate other materials to be formed thereon, and details are not elaborated again. On the other hand, the second flexible substrate 180 may also be fabricated on another carrier (not shown) in a similar manner. The thickness of the second flexible substrate 180 may be as described above and is not elaborated again, but the present disclosure is not limited thereto.

In an embodiment, the transistor array layer 130 may be formed on the first flexible substrate 110 to form the first substrate set 32. The transistor array layer 130 may include (but not limited to) a plurality of thin-film transistors 131, a plurality of data lines (not shown), a plurality of gate lines (not shown), a dielectric layer 137, a dielectric layer 138, a bonding pad 35, other wires or electronic components (not shown). The configuration of the reflective pixel electrode 136 and the thin-film transistor 131 may be as described above, and is not elaborated again.

In addition, the filter layer 160, the second buffer layer 170 and the common electrode 153 may also be formed on the second flexible substrate 180 of another carrier to form the second substrate set 31. The structure of the filter layer 160 and the materials of the common electrode 153 may be as described above, and are not elaborated again.

Next, the second substrate set 31 and the first substrate set 32 obtained in the above steps are aligned to form a large plate structure. It should be noted that, in the present disclosure, the large plate structure is an overall structure after the second substrate set 31 and the first substrate set 32 are aligned and before being cut into multiple display panels, and the main parts of the entire large plate structure are the first flexible substrate 110 and the second flexible substrate 180, and the other parts are optional. In other words, after the alignment the second substrate set 31 and the first substrate set 32 and before the large plate structure is cut into multiple display panels, the overall structure which is formed by adding or removing some elements may still be referred to as the large plate structure.

In the alignment step, for example, the position and/or the direction of the carrier 111 of the second substrate set 31 and of the first substrate set 32 are respectively adjusted, and the plurality of reflective pixel electrodes 136 in the transistor array layer 130 respectively correspond to the positions of a plurality of color filters 161 in the filter layer 160. In addition, a liquid crystal layer 154 and a sealant 155 for fixing may be added between the second substrate set 31 and the first substrate set 32 and the liquid crystal layer 154 may be sealed in the space defined by the sealant 155.

When the second substrate set 31 and the first substrate set 32 form the large plate structure after the assembling step, the carrier (not shown) on the second substrate set 31 is removed. Then, the large plate structure may be cut into multiple display panels by a rotary cutter or laser. When cutting, each display panel may have a reserved bonding pad 35. The bonding pad 35 may comprise a conductive layer in the transistor array layer 130 to extend toward the edge of the first flexible substrate 110 to form the outer lead bonding (OLB), so the bonding pad 35 may be a part of the transistor array layer 130, but the present disclosure is not limited thereto. For example, the bonding pad 35 may also comprise the material on the same layer of the reflective pixel electrode 136 to be disposed above the transistor array layer 130, but the location of the bonding pad 35 is not limited to this.

Then, an integrated circuit (IC, not shown) or a circuit board 34 may be electrically connected to the bonding pad 35 of the display panel. The circuit board 34 may be, for example, a flexible printed circuit (FPC), and the integrated circuit may be, for example, a control chip or a driver chip of the reflective flexible display device 30. The thickness of the circuit board 34 may be between 200 μm and 300 μm, but the present disclosure is not limited thereto.

In some embodiments of the present disclosure, a waterproof glue 33 may be used to protect the integrated circuit or the circuit board 34 on the bonding pad 35 of the transistor array layer 130. For example, after the electrical connection between the circuit board 34 and the bonding pad 35 is completed, the waterproof glue 33 is used to cover the circuit board 34 on the bonding pad 35, and the waterproof glue 33 may be further used to fill the gap 36 around the circuit board 34 to protect or seal the circuit board 34, or to reduce the invasion of moisture, but the present disclosure is not limited thereto. In some embodiments of the present disclosure, the waterproof glue 33 may respectively connect the second flexible substrate 180, the second buffer layer 170, the light-shielding layer 163 in the filter layer 160, the common electrode 153, the sealant 155, the protective layer 140, the dielectric layer 137, the dielectric layer 138, the bonding pad 35 (not shown in the figure) or the first flexible substrate 110 (not shown in the figure) . . . etc., but the present disclosure is not limited thereto. The material of the waterproof glue 33 may be a tuffy glue, but the present disclosure is not limited thereto.

Next, for example, an attachment step of the optical layer 190 may be carried out to attach the optical layer 190 of an appropriate size to the display panel. For example, the optical layer 190 of an appropriate size may be attached to the second flexible substrate 180 or to the waterproof glue 33. The optical layer 190 may be respectively in direct connected the second flexible substrate 180 or the waterproof glue 33. The thickness of the optical layer 190 is approximately 130 μm, but the present disclosure is not limited thereto.

After the above-mentioned steps, the reflective flexible display device 30 of the third embodiment of the present disclosure as shown in FIG. 3 may be obtained with a smaller overall thickness. The reflective flexible display device 30 may include the structure of the reflective flexible display device of the third embodiment of the present disclosure. The liquid crystal layer 154 may be disposed between the first flexible substrate 110 and the second flexible substrate 180, and the circuit board 34 is electrically connected to the bonding pad 35. The reflective pixel electrode 136 may reflect the incident light (not shown) from the outside to form an image of the reflective flexible display device 30.

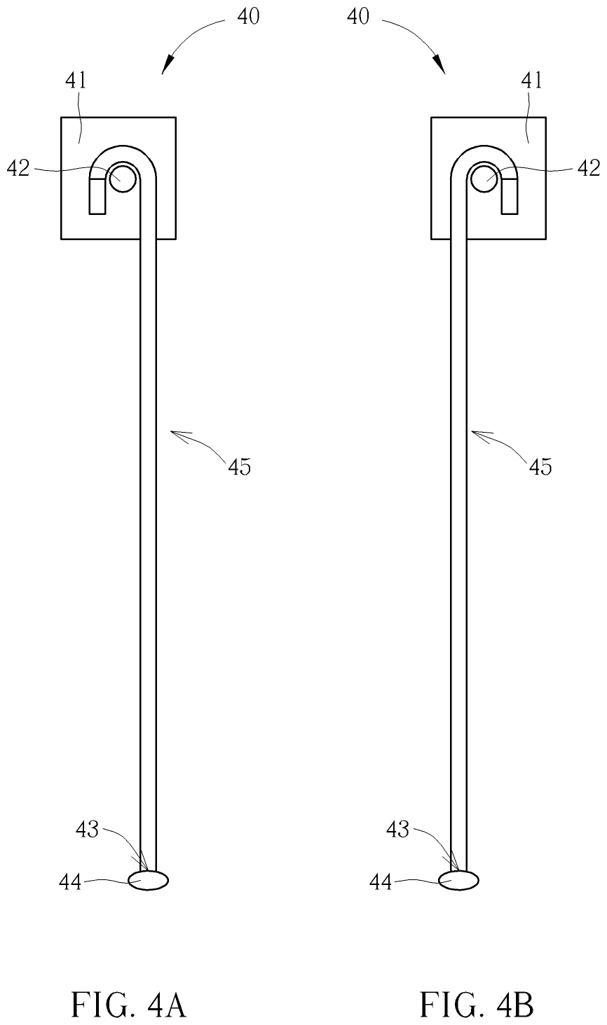

FIG. 4A is a schematic diagram of the reflective flexible display device of the fourth embodiment of the present disclosure, and the structures of some elements are shown in a side view. In an embodiment of the reflective flexible display device 40 according to the fourth embodiment of the present disclosure, the reflective flexible display device 40 may be hung on a wall, on a bracket, on a beam, on a ceiling or on a rope in a suspended manner, but the present disclosure is not limited thereto. The reflective flexible display device 40 may extend outward from a storage box 41 or be scrolled around a reel 42 as the axis, and may be unrolled downward. Optionally, a weight 44 may be added to a bottom edge 43 of the reflective flexible display device 40 to assist or stabilize the flat state of the reflective flexible display device 40. In FIG. 4A, a display surface 45 of the reflective flexible display device 40 may be the outer side when it is rolled.

In another embodiment of the reflective flexible display device 40 of the fourth embodiment of the present disclosure, as shown in FIG. 4B, the display surface 45 of the reflective flexible display device 40 may also be the inner side when it is rolled. In other words, the reflective flexible display device 40 of the present disclosure shown in FIG. 4A or in FIG. 4B may be used as a scroll-hanging type flexible display device, but the present disclosure is not limited thereto. In use, the reflective flexible display device 40 may extend outward from the storage box 41 around the reel 42 as the axis, and may be unrolled downward, but the present disclosure is not limited to this. In storage, the reflective flexible display device 40 may be accommodated in the storage box 41 and scrolled around the reel 42 as the axis, but the present disclosure is not limited thereto. The reflective flexible display device 40 may be accommodated in the storage box 41 to reduce the space occupied by the reflective flexible display device 40, to facilitate storage, or may be easily moved or stored.

The electronic devices in various embodiments of the disclosure, such as the reflective flexible display device, may comprise the first flexible substrate and the second flexible substrate including polymer materials to reduce the total thickness of the reflective flexible display device and the reflective flexible display device of the present disclosure may be beneficial to storing or has a lighter weight to become a portable electronic product which may be easily moved. Various embodiments may be optionally combined as long as they are compatible with one another without violating the gist of the invention or without conflict.

Those skilled in the art will readily observe that numerous modifications and alterations of the device and method may be made while retaining the teachings of the disclosure. Accordingly, the above disclosure should be construed as limited only by the metes and bounds of the appended claims.

1. A reflective flexible display device, comprising:
a first flexible substrate;
a second flexible substrate;
a waterproof glue connected the second flexible substrate;
a liquid crystal layer disposed between the first flexible substrate and the second flexible substrate; and
a reflective pixel electrode disposed on the first flexible substrate;
wherein a CIELAB b* coordinate of the second flexible substrate is less than or equal to a CIELAB b* coordinate of the first flexible substrate.

2. The reflective flexible display device of claim 1, wherein a thickness of the first flexible substrate and the second flexible substrate is respectively between 1 μm and 45 μm.

3. The reflective flexible display device of claim 1, wherein a thickness of the first flexible substrate and the second flexible substrate is respectively between 30 μm and 40 μm.

4. The reflective flexible display device of claim 1, wherein a material of the second flexible substrate is different from a material of the first flexible substrate.

5. The reflective flexible display device of claim 1, wherein the CIELAB b* coordinate of the second flexible substrate is less than or equal to 10.

6. The reflective flexible display device of claim 1, wherein the CIELAB b* coordinate of the first flexible substrate is greater than or equal to 10.

7. The reflective flexible display device of claim 1, further comprising:
an optical layer disposed between the first flexible substrate and the second flexible substrate, and the optical layer adjusts an optical property of the reflective flexible display device.

8. The reflective flexible display device of claim 7, wherein the optical layer comprises a retardation layer.

9. The reflective flexible display device of claim 8, wherein an out-of-plane retardation of the retardation layer is between 30 nm and 300 nm.

10. The reflective flexible display device of claim 1, wherein the reflective flexible display device is a scroll-type hanging display device.

11. The reflective flexible display device of claim 10, wherein the reflective flexible display device extends outward from a storage box.

12. The reflective flexible display device of claim 10, wherein the reflective flexible display device is scrolled around a reel.

13. The reflective flexible display device of claim 1, further comprising:
a plurality of spacers provided between the first flexible substrate and the second flexible substrate.

14. The reflective flexible display device of claim 1, further comprising:
at least one buffer layer disposed on a surface of one of the first flexible substrate and the second flexible substrate.

15. The reflective flexible display device of claim 1, further comprising:
a transistor array layer disposed on the first flexible substrate.

16. The reflective flexible display device of claim 1, wherein transparency of the first flexible substrate and transparency of the second flexible substrate are different.

17. (canceled)

18. The reflective flexible display device of claim 1, wherein a glass transition temperature (Tg) of the first flexible substrate is greater than 250° C.

19. The reflective flexible display device of claim 7, wherein the optical layer comprises an optical compensation film.

20. The reflective flexible display device of claim 7, wherein the optical layer comprises a polarizing film.
